(19) United States
(12) Patent Application Publication
(10) Pub. No.: US 2002/0093429 A1
(43) Pub. Date: Jul. 18, 2002

(54) Medication-taking confirmation support device

(76) Inventors: Yoshiharu Matsushita, Yokohama (JP); Noriko Matsushita, Yokohama (JP); Miho Uchida, Yokohama (JP)

Correspondence Address: McGinn & Gibb, PLLC, Suite 200, 8321 Old Courthousr Road, Vienna, VA, 22182-3817, US

(21) Appl. No.: 10/042,180

(22) Filed: Jan. 11, 2002

(30) Foreign Application Priority Data
Jan. 16, 2001 (JP) 2001-007570

(51) Int. Cl. G08B 23/00

(52) U.S. Cl. 340/573.1; 340/540

(57) ABSTRACT

A medication-taking confirmation support device includes a pill case having a pill housing section, an electronic clock equipped with a memory, a notification unit and a controller, a pill case open/close sensor, and a reconfirmation signal input device. The controller makes the notification unit notify a medication-taking confirmation time on the basis of a detection signal from the pill case open/close sensor and also makes the memory store the medication-taking confirmation time at the time of taking medication. The controller further makes the notification unit re-notify the medication-taking confirmation time read out from the memory on the basis of a signal from the reconfirmation signal input device after having taken medication.

### BACKGROUND OF THE INVENTION

1. Field of the Invention

The present invention generally relates to a medication-taking confirmation support device which assists a patient (or his or her caretaker) to memorize and also to remember that the patient has taken medication at the time of and after taking medication, respectively.

2. Description of the Related Art

In today's society which is changing greatly and aging rapidly, not only patients under medical treatment in a hospital or at their home, but also many people working ordinarily take medication daily. However, many patients are anxious about whether they have taken their medication or not. Especially, people are very nervous about taking medication and tend to handle medication cautiously, especially those who are given medication which does not work unless a fixed amount thereof is taken daily. To do otherwise may cause harmful side effects, especially leading to a fatal result when taking the medication doubly or failing to take it at all. However, it often happens that they could not remember whether they have taken a medication or not. Accordingly, uneasiness as mentioned above is considerably great.

Many times, patients cannot remembering taking medication or not when their usual routines are interrupted by an unexpected telephone call or by visitors at the predetermined time of taking medication in the case of taking medication daily. Further, the older the patient becomes, the more likely that the patient cannot remember whether they have taken medication or not.

A reason for not being able to remember daily taking of their medication arises in that a person taking medication (hereinafter referred to as “a patient”) or his or her caretaker heedlessly remembers the taking medication. In other words, they remember it unconsciously without stimulation to their five senses.

Such situations occur even at the health welfare facilities such as homes for the aged where caretakers such as care-workers or nurses are working. The caretakers help patients take their medication.

However, when a patient is sleeping at the predetermined time of taking medication or the patient is not in a condition to take medication because of excessive excitement or the like, or when an urgent matter arises, the caretaker sometimes delays giving the patient their medication. Meanwhile, each caretaker typically cares for a plurality of patients (e.g., more than ten or more), so that he or she sometimes may not remember having helped the patient take their medication or not.

There are several conventional methods for overcoming the abovementioned uneasiness and anxiety faced by the patient.

A first method is to take, on a note or memo pad or a record book for exclusive use, a note to that effect immediately after having taken medication. However, this method cannot be adopted typically except by very methodical patients. Moreover, even though a duty to take notes is imposed on caretakers like care-workers or nurses working at the health welfare facilities, as a practical matter, it is impossible for them to record each occurrence immediately after having taken care of patients.

A second method for overcoming the above-mentioned uneasiness is to use a pill case separately housing each type of pill. That is, medications to be taken are separately housed in advance. The separately housing-type pill case uses a unique pill box or pill bag. Various kinds of such pill cases are available on the market.

However, in addition to taking the medication, a relatively hard task of separately housing medication in the case is imposed. Thus, this method also cannot be adopted except by very methodical patients.

Hence, improvement of the unique pill case or pill bag on the market has been attempted, for example, as disclosed in Japanese Utility Model Publication (TOROKU) Nos. 3004078, 3026792, 3035809 and in Unexamined Japanese Patent Publication (KOKAI) No. Hei 11-244357. However, products superior to the conventional ones on the market have not been developed.

A third method to overcome the above-mentioned uneasiness is to use a timer or an alarm clock apparatus having a predetermined time set up for taking medication (e.g., as disclosed in Unexamined Japanese Utility Model Publication (KOKAI) Nos. Hei 2-6047, Hei 6-136 and in Unexamined Japanese Patent Publication (KOKAI) No. Hei 7-299124).

However, this method is useful only if the time for taking medication is fixed everyday. That is, if the time is not predetermined such as after every meal in the morning, at noon and in the evening, then it is impossible to set the timer.

Additionally, patients taking medication over a week or several weeks owing to an acute disease, or over several months or more owing to a chronic disease cannot predetermine, in many opportunities, the time for taking medication just like after every meal in the morning, at noon and in the evening. Although the time may be set for taking medication such as 30 minutes after every meal, it is troublesome for patients to set the timer each time they have finished their meals.

Thus, it is troublesome for patients to set the timer in addition to actually taking their medication, and there is the possibility of forgetting to set the timer. Hence, this conventional method also is not acceptable to patients except by very methodical patients.

### SUMMARY OF THE INVENTION

In view of the foregoing and other problems, drawbacks, and disadvantages of the conventional methods and structures, an object of the present invention is to provide a method and structure which assists a patient or a caretaker to positively and easily remember when the patient has taken medication.

Another object is to assist a patient or a caretaker to easily and surely remember the time of having taken medication when they are uneasy or anxious about whether the patient has taken their medication or not.

In a first aspect of the present invention, a medication-taking confirmation support device according to the present invention includes, in combination, a pill case having a pill housing section, an electronic clock equipped with a memory, a notification unit and a controller, and a pill case open/close sensor.

This device makes a patient or a caretaker remember consciously that the patient has taken medication by automatically detecting inevitable actions when taking out medication stored in the pill case at the time of taking medication by the pill case open/close sensor, and by stimulating their five senses on the basis of a detection signal from the pill case open/close sensor by the controller.

In sum, the medication-taking confirmation support device for solving the first problem provides a memory-promoting function for assisting the patients or the caretakers to consciously remember that the patient has taken their medication at the time of taking the medication.

The above-mentioned function includes at least function for making a display unit of the electronic clock notify a medication-taking confirmation time on the basis of a detection signal from the pill case open/close sensor. Needless to say, the medication-taking confirmation time is the time when it has been confirmed that a patient has taken medication, and more specifically the time when the detection signal from the pill case open/close sensor is generated.

In a second aspect of the present invention, a medication-taking confirmation support device according to the present invention includes the memory-call-back support function for making a memory of the electronic clock store the medication-taking confirmation time at the time of taking medication, for displaying on the display unit of the electronic clock the medication-taking confirmation time read out from the memory on the basis of a signal from the reconfirmation signal input device after having taken medication, and for supporting the patient or the caretaker to remember their actions at the medication-taking-confirmation time displayed.

In sum, the medication-taking confirmation support device for solving the second problem provides the memory-call-back support function for assisting the patients or the caretakers to easily remember that the patient has taken their medication.

Thus, in a preferred embodiment, a medication-taking confirmation support device for solving the first and the second problems according to the present invention includes, in combination, a pill case having a pill housing section, an electronic clock equipped with a memory, a notification unit and a controller, a pill case open/close sensor, and a reconfirmation signal input device.

Under the control of the controller, the notification unit notifies a medication-taking confirmation time on the basis of a detection signal from the pill case open/close sensor and the memory stores the medication-taking confirmation time at the time of taking medication, and the notification unit re-notifies the medication-taking confirmation time read out from the memory on the basis of a signal from the reconfirmation signal input device after having taken the medication.

Furthermore, in a second preferred embodiment of the present invention, a medication-taking confirmation support device for solving the first and the second problems includes, in combination, a pill case having a pill housing section, an electronic clock equipped with a memory, a notification unit and a controller, a pill case open/close sensor, a reconfirmation signal input device, and a sound (e.g., music) box for starting and stopping its performance in response to an open-and-close of the pill case.

Under the control of the controller, the notification unit notifies a medication-taking confirmation time on the basis of a detection signal from the pill case open/close sensor and the memory stores the medication-taking confirmation time at the time of taking medication, and the notification unit re-notifies the medication-taking confirmation time read out from the memory unit on the basis of a signal from the reconfirmation signal input device after having taken medication.

Preferably, in both embodiments, the pill housing section is formed to be covered with a lid, and the medication-taking confirmation time is the time when a detection signal is generated by the pill case open/close sensor which detects the closing of the lid.

Additionally, the pill housing section may be a drawer-type pill housing section, and the medication-taking confirmation time is the time when a detection signal is generated by the pill case open/close sensor when the drawer is returned to a drawer-housing section.

Further, in both embodiments, sections may be provided for storing the used PTP packing, vinyl packs, medication wrapping papers, split wrapping papers, etc. (hereinafter referred to as “medication wrapping papers” or the like), so that it can be confirmed whether the medication is taken doubly.

The present disclosure relates to subject matter contained in Japanese Patent Application No. 2001-7570, filed on Jan. 16, 2001, which is expressly incorporated herein by reference in its entirety.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a circuit block diagram showing a first embodiment of the medication-taking confirmation support device according to the present invention;

FIG. 2 is a circuit block diagram showing a second embodiment of the medication-taking confirmation support device according to the present invention;

FIG. 3 is a flow chart of the first embodiment of the medication-taking confirmation support device according to the present invention at the time of taking medication;

FIG. 4 is a flow chart of the second embodiment of the medication-taking confirmation support device according to the present invention at the time of taking medication;

FIG. 5 is a flow chart of the medication-taking confirmation support device according to the present invention at the time of reconfirmation after taking medication;

FIG. 6 is a flow chart of the medication-taking confirmation support device according to the present invention at the time of a reset operation;

FIG. 7 is a functional block diagram showing the first embodiment of the medication-taking confirmation support device according to the present invention;

FIG. 8 is a block diagram of a circuit showing the second embodiment of the medication-taking confirmation support device according to the present invention;

FIG. 9 is a perspective view of an embodiment of a medication-taking confirmation support device according to the present invention comprising a pill case having a lid, an electronic clock and a mechanical sound (e.g., music) box;

FIG. 10 is a perspective view of another embodiment of a medication-taking confirmation support device according to the present invention comprising a pill case with a drawer and an electronic clock; and

FIG. 11 is a perspective view of still another embodiment of a medication-taking confirmation support device according to the present invention comprising a pill case with a pivot-turn type drawer and an electronic clock.

### DETAILED DESCRIPTION OF PREFERRED EMBODIMENTS OF THE INVENTION

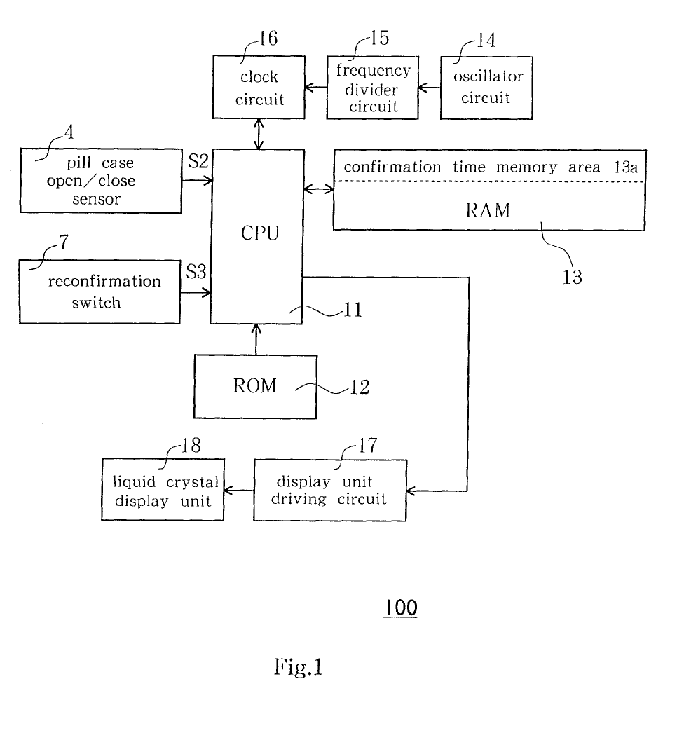

Referring now to the drawings, and more particularly to FIGS. 1-11, there are shown preferred embodiments of the method and structures according to the present invention.

### PREFERRED EMBODIMENTS

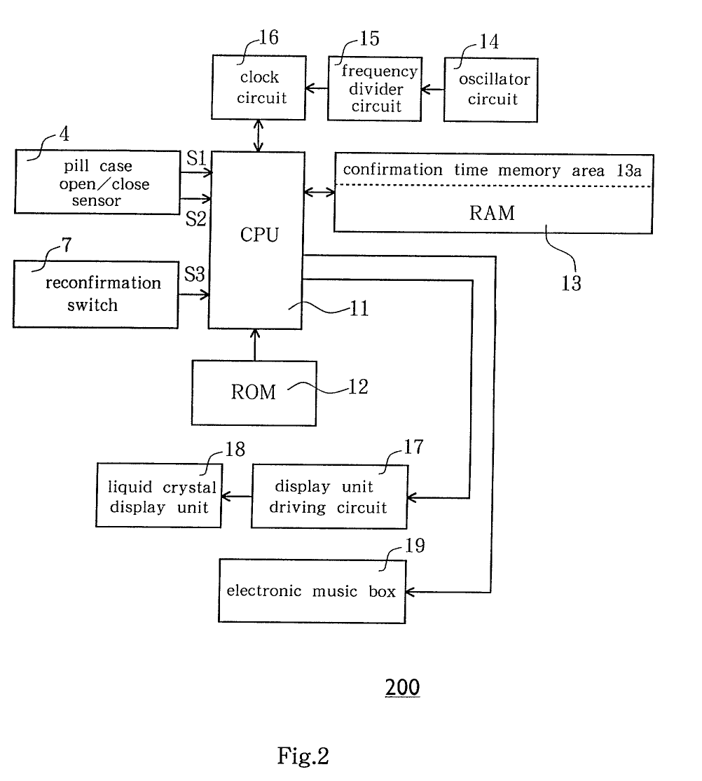

Referring first to FIGS. 1 and 2, a medication-taking confirmation support device of the first and second embodiments of the present invention shown in circuit block diagram will be explained.

First Embodiment

A medication-taking confirmation support device 100 of the first embodiment of the present invention as shown in FIG. 1 is characterized by a pill case open/close sensor and a reconfirmation button.

The device 100 includes CPU 11 for performing various kinds of operation and control in accordance with its program, ROM 12 for storing the program and various kinds of message information, RAM 13 for storing a confirmation time, etc., an oscillator circuit 14 for generating a standard frequency, a frequency divider circuit 15 for dividing the standard frequency into a time clock frequency, a clock circuit 16 for measuring time on the basis of the time clock frequency, a display unit driving circuit 17, a liquid crystal display unit 18, a pill case open/close sensor 4 and a reconfirmation button 7.

The pill case open/close sensor 4, which is a medication-taking confirmation signal generating means, is a commercially-available sensor such as a micro-switch or the like. A patient or a caretaker opens a pill case and then takes medication out of a pill-housing section. The sensor 4 generates a pill case-close signal S2 when the pill case is closed after the patient has taken medication. The signal S2 is input to CPU 11. Thus, the pill case open/close sensor 4 is a sensor for detecting inevitable actions when the patient or the caretaker takes out medication stored in the pill case at the time of taking medication. The reconfirmation button 7 is a switch (e.g., a push button or the like) for inputting a reconfirmation signal S3 to CPU11.

The ROM 12 stores a control program for CPU 11. RAM 13 includes a confirmation time memory area 13a. The confirmation time stored in the confirmation time memory area 13a is the time when the patient or caretaker confirmed taking medication. In the first embodiment, the present time measured by the clock circuit 16 at the moment when pill case-close signal S2 is input into CPU 11 is stored as the confirmation time.

Second Embodiment

A medication-taking confirmation support device 200 of the second embodiment of the present invention as shown in FIG. 2 is characterized by a pill case open/close sensor, a reconfirmation button and an electronic sound (e.g., music) box. The device 200 is formed by adding the electronic sound (e.g., music) box 19 to the device 100 of the first embodiment as shown in FIG. 1.

In the device of the second embodiment, the pill case open/close sensor 4, which is a medication-taking confirmation signal generating means, generates a pill case-open signal S1 when the patient or caretaker opens the pill case to take medication out of the pill housing section and then generates a pill case-close signal S2 when the case is closed after the patient has taken medication. These signals S1 and S2 are input to CPU 11. CPU11 controls the sound (music) box 19 to initiate a sound (musical) performance on the basis of the signal S1 and then stop it on the basis of the signal S2.

Similarly, in the second embodiment, the present time measured by the clock circuit 16 at the moment when the pill case-close signal S2 is input into CPU 11 is stored as the confirmation time.

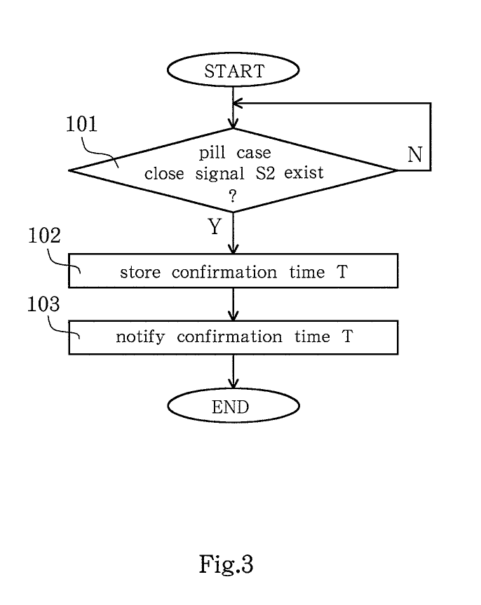

Next, referring to FIGS. 3 to 5, the operation of the medication-taking confirmation support device of the present invention will be explained.

In FIG. 3 showing the operation of the first embodiment of the medication-taking confirmation support device 100, CPU 11 monitors the presence of an input of the pill case-close signal S2 (101).

When CPU 11 detects the signal S2, it makes a confirmation time memory area 13a of RAM 13 store the present time measured by the clock circuit 16 as a confirmation time T (102).

Next, CPU 11 reads out the confirmation time T from the confirmation time memory area 13 a of RAM 13, and controls the display unit driving circuit 17 to display the time T on the liquid crystal display unit 18 (103). An indication of the time on the liquid crystal display 18 calls attention to (e.g., notifies) a user that the time displayed has been stored in the memory portion. Calling attention is accomplished by flashing the indication of the time or making a lamp pulse at the same time of the indication of the time.

After the operation of step 103 ends, CPU 11 terminates the medication-taking confirmation program. The pill case-close signal S2 forms a medication-taking confirming signal.

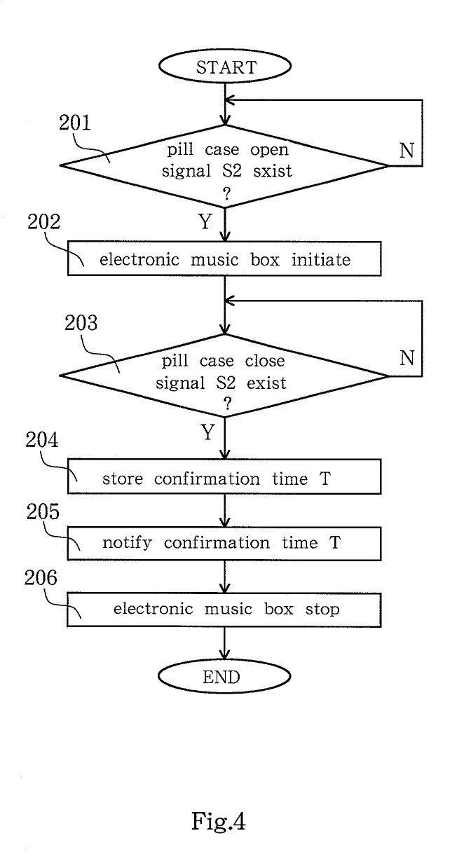

Next, in FIG. 4 showing the operation of the second embodiment of the medication-taking confirmation support device 200, CPU 11 monitors the presence of an input of the pill case-open signal S1 (201).

When CPU 11 detects the pill case-open signal S1, CPU 11 makes a music box 19 initiate its performance by providing it with a control signal (202). Subsequently, CPU 11 monitors the presence of an input of the pill case-close signal S2 (203).

When CPU 11 detects the signal S2, it makes a confirmation time memory area 13 a of RAM 13 store the present time measured by the clock circuit 16 as a confirmation time T (204). Subsequently, CPU 11 reads out the confirmation time T from the confirmation time memory area 13 a of RAM 13, controls the display unit driving circuit 17 to display the time T on the liquid crystal display unit 18 (205).

An indication of the time on the liquid crystal display 18 calls a user's attention to (e.g., notifies) the time displayed has been stored in the memory portion. Calling attention is accomplished by flashing the indication of the time or making a lamp blink at the same time of the indication of the time. Lastly, CPU 11 makes a sound (music) box 19 stop its operation (e.g., performance) by providing it with a control signal (206). After the operation of step 206 ends, CPU 11 terminates the medication-taking confirmation program. The pill case-close signal S2 here forms a medication-taking confirming signal, too.

As evident from the flowchart of FIGS. 3 and 4, by using the medication-taking confirmation support device of the present invention, a patient or his or her caretaker looks at the time displayed on the liquid crystal display unit 18 at the time of taking medication, or pleasantly listens to the melody playing. As a result, as their senses of sight and hearing are excited, they can keep the fact of having taken medication in mind. This is the memory promoting and support effect of the medication-taking confirmation support device 100 (200) of the present invention.

More specifically, it is more vivid to memorize (e.g., remember) “you took medication at 7:23” than “you took medication”. Further, if one remembers the time and melody in such a way that “you took medication at 7:23. At that time the melody, “The maiden's prayer” is heard from the music box, it is obvious that the memory remains more clearly.

As mentioned above, when the patients or the caretakers using the medication-taking confirmation support device 100 (200) of the present invention consciously memorize (remember) the fact of having taken medication by the memory-promoting and support effect at the time of taking medication, it is obvious that the number of times they are seized with uneasiness as to whether the patient has taken medication or not, is greatly reduced in comparison with when they have an unconscious memory.

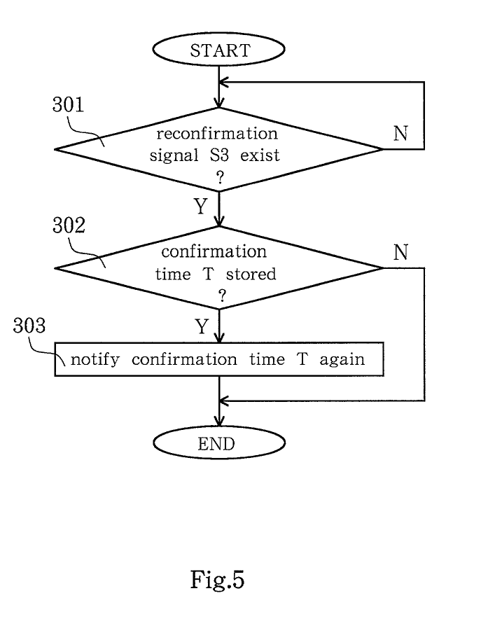

However, even when the patient or caretakers are seized with uneasiness because of failure to remember whether the patient has taken the medication or not, the patients or the caretakers using the medication-taking confirmation support device of the present invention can immediately remove any anxiety. The reconfirmation process for removing the anxiety/uneasiness of whether the patient has taken their medication or not (e.g., when uneasiness arises after taking medication) is conducted in accordance with a flow chart in FIG. 5.

That is, in FIG. 5, when a patient or caretaker operates a reconfirmation button 7, a reconfirmation signal S3 is generated. Then, the medication-taking confirmation support device initiates a medication-taking reconfirmation program.

As CPU 11 monitors the presence of an input of reconfirmation signal S3 (301), it searches the confirmation time memory area 13a of RAM 13 to determine whether the confirmation time T is stored or not upon detection of the reconfirmation signal S3 (302).

If the confirmation time T is not stored, then CPU 11 re-notifies the confirmation time T (303) and terminates the reconfirmation program. The re-notification of the confirmation time T is performed such that the numeral “07:23” is displayed on the liquid crystal display 18. In order to represent that the displayed time is the confirmation time, but not the present time, the message of “CONFIRMED” or the like preferably is displayed on the liquid crystal display 18 together with the indication “07:23.”

Then, the operation of step 303 ends, and CPU 11 terminates the medication-taking reconfirmation program.

Thus, patients (and their caretakers) can re-confirm their taking medication easily and surely. To be more accurate, they can know the time when the pill case was closed after it was opened. Thereafter, patients (or their caretakers) can remember their acts at that time on the basis of the displayed time, and they can reconfirm whether the patient has taken medication or not. As the acts are represented by “the time” and “the position”, the patients can recognize their acts by the time.

Accordingly, even if the patients or the caretakers using the medication-taking confirmation support device with the memory-call-back support function of the present invention have some uneasiness because of their failure to remember whether the patient has taken the medication or not, they can remove their anxiety immediately by using the above-mentioned reconfirmation unit.

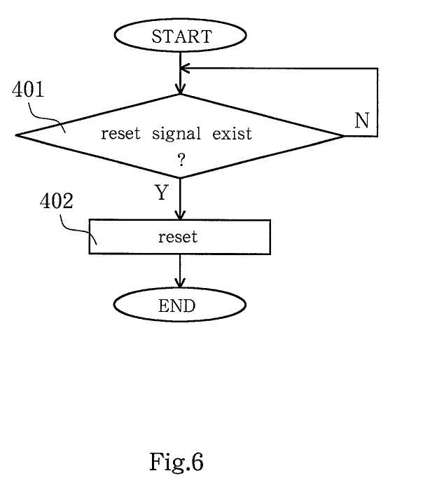

Next, FIG. 6 is a flow chart of the operation of the reset action of the medication-taking confirmation support device of an embodiment of the present invention.

That is, when a reset signal is input, the medication-taking confirmation support device starts a reset program. As CPU 11 monitors the presence of an input of reset signal (401), it resets immediately upon detection of the reset signal (402). After the reset is accomplished, CPU 11 terminates its reset program. The reset signal is generated by a reset switch (not shown), for example. Instead, the pill case open signal S1 can be used as the reset signal.

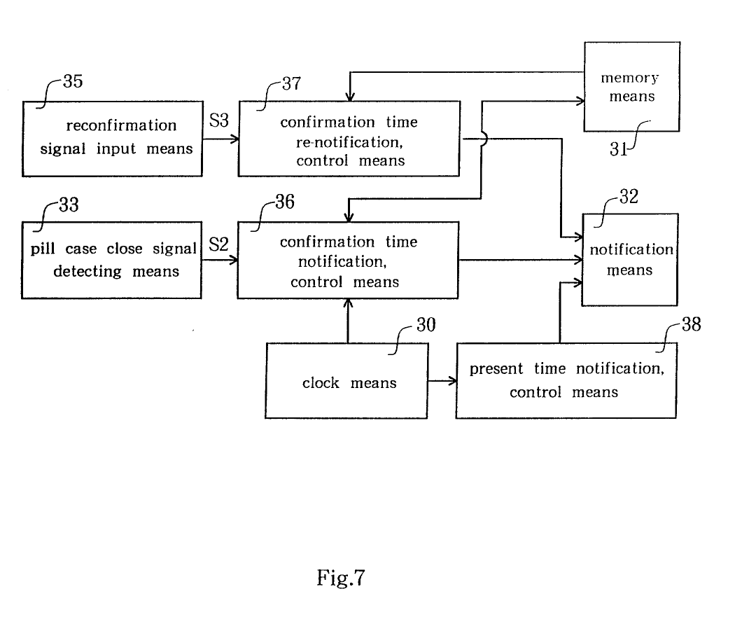

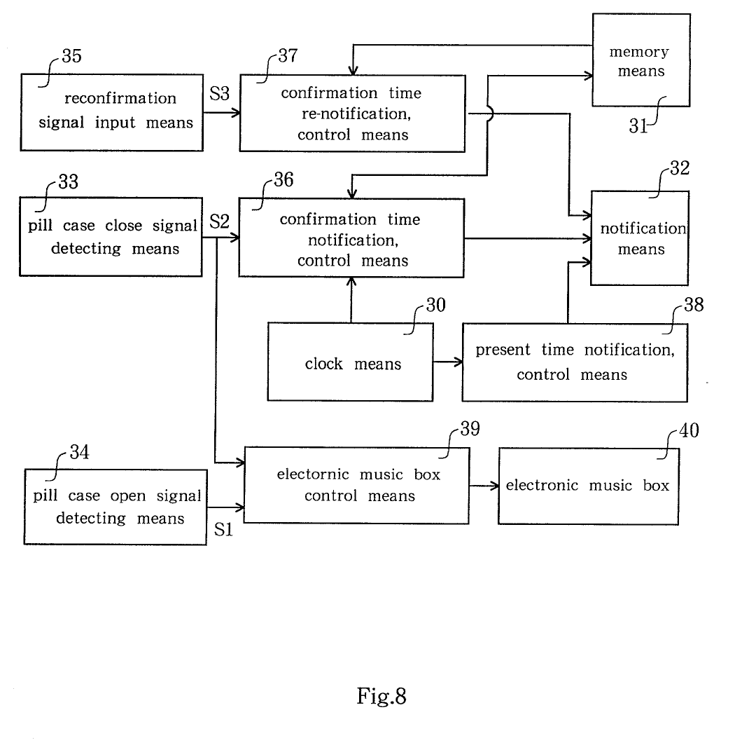

Subsequently, referring to FIGS. 7 and 8, the embodiment of the medication-taking confirmation support device of the present invention will be explained.

FIG. 7 shows a functional block diagram of the medication-taking confirmation support device 100 of the first embodiment of FIG. 1 operating in accordance with a flow chart of FIG. 3.

Namely, the medication-taking confirmation support device 100 of the first embodiment of the present invention of FIG. 7 includes a clock means 30 for measuring time, a memory means 31 for storing various kinds of information, a notification means 32 for indicating the time and others by a graphical display, etc., a pill case close detecting means 33 for detecting pill case open-and-close and generating a pill case close signal S2, a confirmation time notification, control means 36 for making the memory means 31 store the present time measured by the clock means 30 as the confirmation time on the basis of the pill case close signal S2, and for controlling the notification means 32 to notify the confirmation time, a reconfirmation signal input means 35 for inputting reconfirmation signal S3, a confirmation time re-notification, control means 37 for making the notification means 32 re-notify the confirmation time by reading out from memory means 31 on the basis of the reconfirmation signal S3, and a present time notification, control means 38 for making the notification means 32 notify the present time measured by the clock means 30.

Next, FIG. 8 shows a functional block diagram of the medication-taking confirmation support device 200 of the second embodiment of FIG. 2 operating in accordance with a flow chart of FIG. 4.

Namely, the medication-taking confirmation support device of the second embodiment of the present invention of FIG. 8 comprises a clock means 30 for measuring time, a memory means 31 for storing various kinds of information, a notification means 32 for indicating the time and others by a graphical display, etc, a pill case close detecting means 33 for detecting pill case open-and-close and generating a pill case open signal S1 and a pill case close signal S2, a confirmation time notification, control means 36 for making the memory means 31 store the present time measured by the clock means 30 as the confirmation time on the basis of the pill case close signal S2, and for controlling the notification means 32 to notify the confirmation time, a reconfirmation signal input means 35 for inputting reconfirmation signal S3, a confirmation time re-notification, control means 37 for making the notification means 32 re-notify the confirmation time by reading out from memory means 31 on the basis of the reconfirmation signal S3, a present time notification, control means 38 for making the notification means 32 notify the present time measured by the clock means 30, an electronic music box 40, and an electronic music box control means 39 for controlling the start and stop of its performance on the basis of the signals S1 and S2.

Hereinbelow, the comparison of the corresponding constituent elements between the circuit block diagrams of FIGS. 1 and 2 and the functional block diagrams of FIGS. 7 and 8 is described.

That is, the memory means 31 corresponds to the ROM 12 and RAM 13. The notification means 32 corresponds to the display unit driving circuit 17 and the liquid crystal display means 18. The pill case close detecting means 33 and the open detecting means 34 correspond to the pill case open/close sensor 4. The reconfirmation signal input means 35 corresponds to the reconfirmation button 7. The confirmation time notification, control means 36, the confirmation time re-notification, control means 37 and the electronic music box control means 39 correspond to the CPU 11.

The present time notification function of the electronic clock includes the clock means 30, the notification means 32, and the present time notification, control means 38.

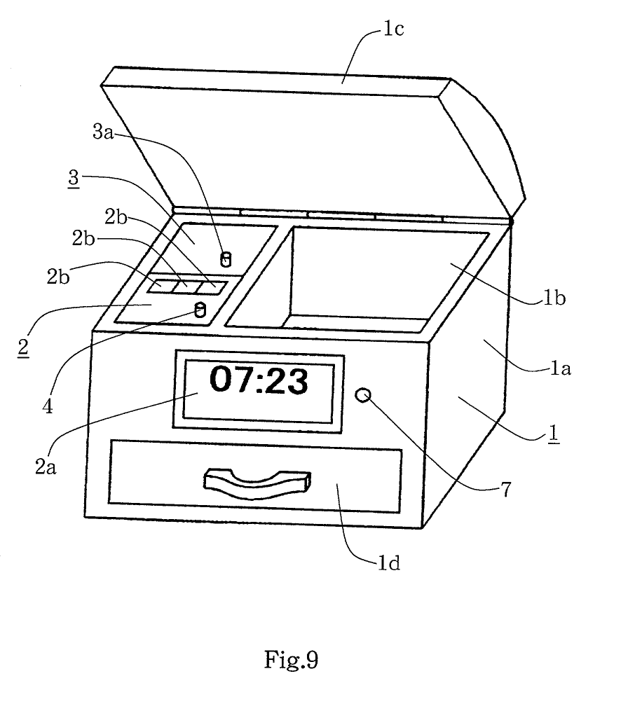

Although the present invention has been explained in detail from the functional point of view by referring to the circuit block diagrams, the flow charts and the functional block diagrams, it will be explained from the structural point of view by referring to FIGS. 9 through 11.

FIG. 9 is a perspective view of an embodiment of a medication-taking confirmation support device according to the present invention comprising a pill case 1 having a lid, an electronic clock 2 and a mechanical music box 3.

In FIG. 9, the pill case 1 with a lid includes a pill case main body la, a pill housing section 1b formed in the pill case main body 1a, a lid 1c mounted to the pill case main body 1a by a hinge, and a drawer 1d formed at the lower portion of the pill case main body 1a. The drawer 1d is used as a section for storing the used papers for wrapping doses of medication, etc.

In a housing section formed next to the pill housing section 1b in the pill case main body 1a, the electronic clock 2 with a time memory means and the mechanical music box 3 having a start-stop pin 3a are fixed. The electronic clock 2 has a liquid crystal display portion 2a and operation buttons 2b for setting the time, etc.

The liquid crystal display portion 2a, which is a notification means for the electronic clock 2, is set up in front of the pill case main body 1a. A reconfirmation button 7 for making a replay of the confirmation time is also set up in front of the pill case main body 1a. A pill case open/close sensor 4 for detecting the opening and closing of the lid 1c of the pill case 1 with a lid is fixed to the case of the electronic clock 2. The pill case open/close sensor 4 generates the pill case open signal S1 when the lid 1c is opened, and the close signal S2 when closed.

In FIG. 9, the mechanical music box 3 may be an electronic music box. In this case, the start-stop pin 3a is not needed. Furthermore, in case of FIG. 9 using the mechanical music box 3, the start-stop pin 3a may be used as the pill case open/close sensor.

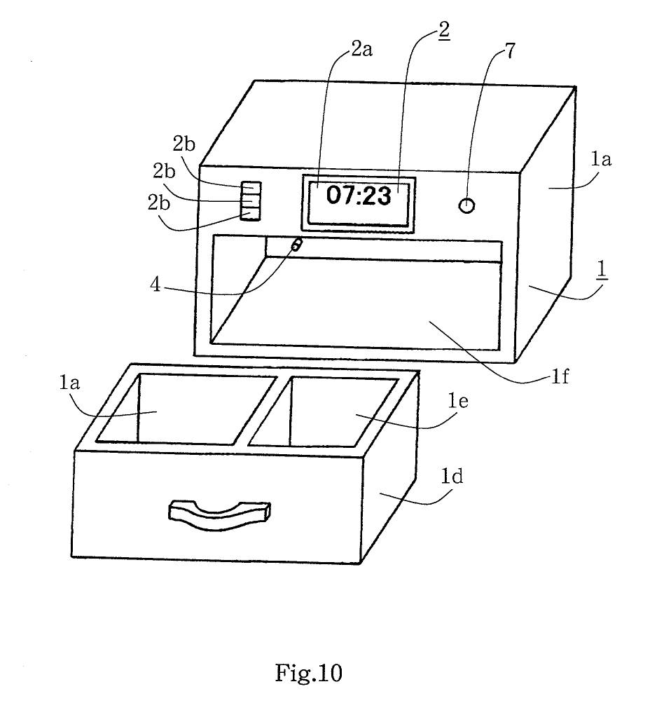

FIG. 10 is a perspective view of another embodiment of a medication-taking confirmation support device according to the present invention including a pill case 1 with a drawer and an electronic clock 2.

In FIG. 10, the pill case 1 with a drawer includes a pill case main body 1a and a drawer 1d attached to a drawer-housing section 1f formed in the pill case main body 1a. Formed in the drawer 1d are the pill housing section 1b and the sections 1e for storing the used papers for wrapping doses of medication, etc.

The electronic clock 2 with the time memory means is positioned at a housing-section formed at the upper portion of the pill case main body 1a. A liquid crystal display portion 2a, which is a notification means of the electronic clock 2, and operation buttons 2b for setting the time, etc., are set up in front of the pill case main body 1a. A reconfirmation button 7 for replaying the confirmation time is also set up in front of the pill case main body 1a.

Further, a pill case open/close sensor 4 is fixed on a back plate of the drawer-housing section If in the pill case main body la. The pill case open/close sensor 4 generates the pill case close signal S2 when the drawer Id is returned to the drawer-housing section If after the drawer Id is pulled out.

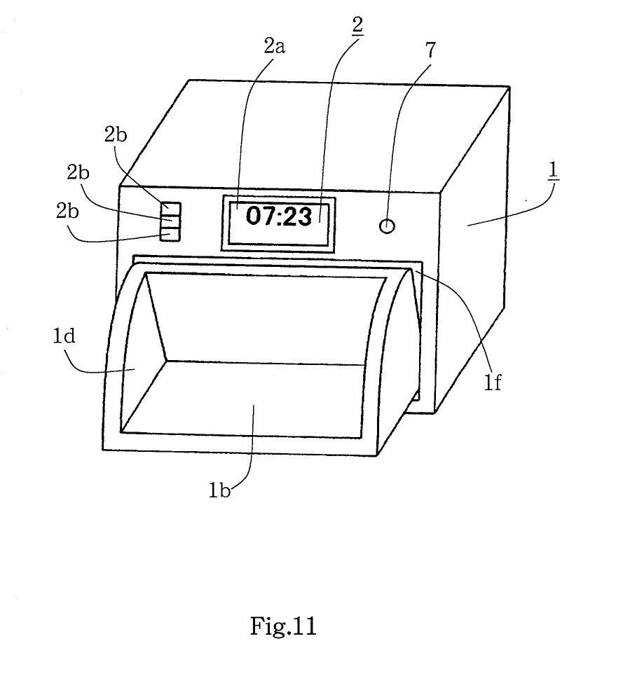

FIG. 11 is a perspective view of still another embodiment of a medication-taking confirmation support device according to the present invention comprising a pill case 1 with a pivot-turn type drawer and an electronic clock 2.

In FIG. 1, the pill case 1 with a pivot-turn type drawer includes a pill case main body 1a and a pivot-turn type drawer 1d attached at pivotally turn-around 90 degrees to a drawer-housing section 1f formed in the pill case main body 1a. Formed in the drawer 1d is a pill housing section 1b.

The electronic clock 2 with the time memory means is positioned at a housing-section formed at the upper portion of the pill case main body 1a. A liquid crystal display portion 2a, which is a notification means of the electronic clock 2, and operation buttons 2b for setting the time, etc., are set up in front of the pill case main body 1a. A reconfirmation button 7 for making a replay of the confirmation time is also set up in front of the pill case main body 1a.

Further, a pill case open/close sensor 4 (not shown) is fixed on a back plate of the drawer-housing section 1d in the pill case main body 1a. The pill case open/close sensor 4 generates the pill case close signal S2 when the drawer 1d is returned to the drawer-housing section 1f after the drawer 1d is pivoted out.

In the meantime, a notification of the confirmation time is disclosed as those displayed on the liquid crystal display, but it may be notified by a sound (audio) message such as “It is 7:23.” If the notification of the confirmation time via the sound message is performed simultaneously with the image display, then the effect of the notification will be increased.

The notification via the sound message is implemented preferably by adding a speaker and a sound compound generating circuit to the block circuit of FIGS. 1 and 2. Furthermore, an animation or still characters of animals, etc., may be displayed together with the confirmation time as the memory promoting support function.

As obvious from the detailed explanation above, the medication-taking confirmation support device of the present invention assists a patient or a caretaker to vividly remember via their five senses that the patient has taken medication by making the notification means notify the present time measured by the electronic clock as the medication-taking confirming time at the time of taking medication to more secure the assistance of confirmation of taking medication.

Furthermore, the medication-taking confirmation support device of the present invention assists a patient or a caretaker to remember their acts at the confirmation time by making the notification means re-notify the present time stored in the memory means upon pressing the reconfirmation button when they cannot remember whether the patient has taken medication or not (after in fact taking their medication). Accordingly, the assistance of reconfirmation of taking medication is done easily and surely by the present medication-taking confirmation support device.

Furthermore, when the medication-taking confirmation support device of the present invention includes a pill case having a key, a lock and unlock sensor for detecting locking or unlocking may be used as a pill case open/close sensor. Such a pill case having keys, if a plurality of pill housing sections are made therein and each of the sections are opened and closed by the keys, will be convenient to use at the health welfare facilities such as homes for the aged where a plurality of patients are living in one room.

As the medication-taking confirmation support device of the present invention can be made by using commercially-available constituent parts or materials of a pill case, an electronic clock, a music box and pill case open/close sensor, etc., the inventive device can be made in large quantities and at low price.

Further, if the confirmation time for a long period such as over a week or one month is stored in the memory means of the medication-taking confirmation support device of the present invention, it is useful to confirm the history of a patient's taking medication. In this case, the history of the stored confirmation time may be printed by a printer as well as being indicated on a display unit. In such a case, the notification means may notify or indicate year, month and day together with the confirmation time.

Thus, with the unique and unobvious aspects of the present invention, even if patients or their caretakers cannot remember whether the patients have taken their medication or not, the amount of uneasiness/anxiety can be greatly reduced by using the medication-taking confirmation support device of the present invention having the memory promoting support function and memory call-back support function for several reasons.

For example, the memory promoting support function works on the basis of the detection signal from the pill case open/close sensor for detecting inevitable acts at the time of taking medication stored in the pill case, and that the five human senses are stimulated. Thus, medication-taking confirmation at the time of taking medication can be conducted easily and surely. Hence, as patients or their caretakers can memorize (remember) consciously the taking of their medication by using the medication-taking confirmation support device of the present invention, and their memory remains clear and vivid.

Further, even if patients or their caretakers cannot remember whether the patients have taken medication or not and have been seized with anxiety, their anxiety/uneasiness can be immediately removed by using the medication-taking confirmation support device of the present invention having the memory promoting support function and memory call-back support functions.

Indeed, when patients (or their caretakers) are seized with uneasiness after having taken medication, the patients (or their caretakers) can remember their acts at the time of the confirmation time and reconfirm whether the patients have taken medication or not easily and surely by replaying the confirmation time on the display unit upon pressing the reconfirmation button.

While the invention has been described in terms of several preferred embodiments, those skilled in the art will recognize that the invention can be practiced with modification within the spirit and scope of the appended claims.

What is claimed is:

1. A medication-taking confirmation support device, comprising:
a pill case having a pill housing section;
an electronic clock equipped with a memory means, a notification means and a control means;
a pill case open/close sensor; and
a reconfirmation signal input means,
wherein said control means makes said notification means notify a medication-taking confirmation time on the basis of a detection signal from the pill case open/close sensor and also makes said memory means store the medication-taking confirmation time at the time of taking medication, and
wherein said control means makes said notification means re-notify the medication-taking confirmation time read out from said memory means on the basis of a signal from said reconfirmation signal input means after having taken medication.

2. A medication-taking confirmation support device according to claim 1,
wherein said pill housing section is formed to be covered with a lid.

3. A medication-taking confirmation support device according to claim 2, wherein the time when said pill case open/close sensor detects the closing of the lid and generates the detection signal comprises said medication-taking confirmation time.

4. A medication-taking confirmation support device according to claim 1, wherein said pill housing section comprises a drawer-type pill housing section.

5. A medication-taking confirmation support device according to claim 4, wherein the time when said pill case open/close sensor detects that the drawer is returned to a drawer-housing section and generates the detection signal comprises said medication-taking confirmation time.

6. A medication-taking confirmation support device according to claim 1, wherein said pill case has sections for storing a used wrapper for wrapping a dose of medication.

7. A medication-taking confirmation support device, comprising:
a pill case having a pill housing section;
an electronic clock equipped with a memory means;
a notification means and a control means;
a pill case open/close sensor;
a reconfirmation signal input means; and
a sound box for starting and stopping its performance in response to an opening and closing of the pill case, respectively,
wherein said control means makes said notification means notify a medication-taking confirmation time on the basis of a detection signal from the pill case open/close sensor and also makes said memory means store the medication-taking confirmation time at the time of taking medication, and
wherein said control means makes said notification means re-notify the medication-taking confirmation time read out from said memory means on the basis of a signal from said reconfirmation signal input means after having taken medication.

8. A medication-taking confirmation support device according to claim 7, wherein said pill housing section is formed to be covered with a lid.

9. A medication-taking confirmation support device according to claim 7, wherein the time when said pill case open/close sensor detects the closing of the lid and generates the detection signal comprises said medication-taking confirmation time.

10. A medication-taking confirmation support device according to claim 7, wherein said pill housing section comprises a drawer-type pill housing section.

11. A medication-taking confirmation support device according to claim 10, wherein the time when said pill case open/close sensor detects that the drawer is returned to a drawer-housing section and generates the detection signal comprises said medication-taking confirmation time.

12. A medication-taking confirmation support device according to claim 7, wherein said pill case has sections for storing a used wrapper for wrapping a dose of medication.

13. A medication-taking confirmation support device according to claim 7, wherein said sound box comprises a music box.

14. A medication-taking confirmation support device, comprising:
a pill case having a pill housing section;
an electronic clock equipped with a memory, a notification unit and a controller;
a pill case open/close sensor; and
a reconfirmation signal input device,
wherein said controller makes said notification unit notify a medication-taking confirmation time on the basis of a detection signal from the pill case open/close sensor and also makes said memory store the medication-taking confirmation time at the time of taking medication.

15. A medication-taking confirmation support device according to claim 14, wherein said controller makes said notification unit re-notify the medication-taking confirmation time read out from said memory on the basis of a signal from said reconfirmation signal input device after having taken medication.

16. A medication-taking confirmation support device according to claim 14, further comprising:
a sound box for starting and stopping its performance in response to an opening and closing of the pill case, respectively.

17. A medication-taking confirmation support device according to claim 14,
wherein said pill housing section is formed to be covered with a lid.

18. A medication-taking confirmation support device according to claim 17, wherein the time when said pill case open/close sensor detects the closing of the lid and generates the detection signal comprises said medication-taking confirmation time.

19. A medication-taking confirmation support device according to claim 14, wherein said pill housing section comprises a drawer-type pill housing section,
wherein the time when said pill case open/close sensor detects that the drawer is returned to a drawer-housing section and generates the detection signal comprises said medication-taking confirmation time.

20. A medication-taking confirmation support device according to claim 14, wherein said pill case has sections for storing a used wrapper for wrapping a dose of medication.
